(19) United States
(12) Patent Application Publication
(10) Pub. No.: US 2021/0383411 A1
(43) Pub. Date: Dec. 9, 2021

(54) Enhanced Location Analytics by Combining 802.11ay Wi-Fi Location Sensing with Emotional Quotient

(71) Applicant: Cisco Technology, Inc., San Jose, CA (US)

(72) Inventors: Rajesh S. Pazhyannur, Fremont, CA (US); Anand Oswal, Pleasanton, CA (US); Arun G. Khanna, Sunnyvale, CA (US); Kedar Gaonkar, San Jose, CA (US)

(21) Appl. No.: 16/895,302

(22) Filed: Jun. 8, 2020

(51) Int. Cl. G06Q 30/02; H04W 4/38; G06K 9/00

(52) U.S. Cl. CPC G06Q 30/0201; H04W 4/38; G06K 2009/00939; G06K 9/00885; G06K 9/00315

(57) ABSTRACT

The present disclosure is directed to enhanced location analytics based on 802.11ay Wi-Fi technology and includes one or more processors and one or more computer-readable non-transitory storage media coupled to the one or more processors and comprising instructions that, when executed by the one or more processors, cause one or more components to perform operations including determining enhanced location information of at least one user in a physical space based on first data received from at least one 802.11ay access point, generating an emotional quotient of the at least one user based on second data received from at least one 802.11ay sensor, combining the location information and the emotional quotient to generate one or more enhanced location analytics associated with the at least one user, and integrating the one or more enhanced location analytics with customer information in a partner database to derive one or more insights.

### TECHNICAL FIELD

The present disclosure generally relates to systems and methods for location analytics, and more specifically to systems and methods for enhanced location analytics by combining 802.11ay Wi-Fi location sensing with an emotional quotient.

### BACKGROUND

Wireless networking, also called Wi-Fi or 802.11 networking, uses radio signals to wirelessly connect devices such as computers, phones, and tablets to the Internet at high speeds in homes, businesses, and public spaces. The Institute of Electrical and Electronics Engineers (“IEEE”) wireless standard 802.11ay (also referred to herein as “11ay”), is one of the next protocols in Wi-Fi technology. Unlike existing Wi-Fi technology, 11ay operates at a higher 60 GHz band, has a transmission rate of approximately 20-40 gigabits per second, and has an extended transmission distance of about 300-500 meters.

### BRIEF DESCRIPTION OF THE DRAWINGS

FIG. 1 illustrates a system for deriving enhanced location analytics by combining 11ay location information and an emotional quotient, in accordance with certain embodiments;

FIG. 2 illustrates a block diagram of a location services platform depicted in the system of FIG. 1, in accordance with certain embodiments;

FIG. 3 illustrates a flow diagram of a method for deriving enhanced location analytics by combining 11ay location information and an emotional quotient, in accordance with certain embodiments; and

FIG. 4 illustrates a computer system, in accordance with certain embodiments.

### DESCRIPTION OF EXAMPLE EMBODIMENTS

### Overview

According to an embodiment, a system may include one or more processors and one or more computer-readable non-transitory storage media comprising instructions that, when executed by the one or more processors, cause one or more components of the system to perform operations including, determining enhanced location information of at least one user in a physical space based on first data received from at least one 802.11ay access point, generating an emotional quotient of the at least one user based on second data received from at least one 802.11ay sensor, combining the location information and the emotional quotient to generate one or more enhanced location analytics associated with the at least one user, and integrating the one or more enhanced location analytics with customer information in a partner database to derive one or more insights.

Moreover, the at least one 802.11ay sensor includes one or more millimeter wave sensors. Additionally, the second data includes emotional characteristics indicating an emotion of the at least one user.

Further, the emotional characteristics comprises at least one of facial expressions, gestural movements, and cardiac rhythms. The at least one of the location information and the emotional quotient are generated in real-time.

Moreover, the one or more insights are associated with user behavior in the physical space. Additionally, the partner database stores customer information relating to a plurality of users.

According to another embodiment, a method may include the steps of determining enhanced location information of at least one user in a physical space based on first data received from at least one 802.11ay access point, generating an emotional quotient of the at least one user based on second data received from at least one 802.11ay sensor, combining the location information and the emotional quotient to generate one or more enhanced location analytics associated with the at least one user, and integrating the one or more enhanced location analytics with customer information in a partner database to derive one or more insights.

According to yet another embodiment, one or more computer-readable non-transitory storage media may embody instructions that, when executed by a processor, cause the performance of operations, including determining enhanced location information of at least one user in a physical space based on first data received from at least one 802.11ay access point, generating an emotional quotient of the at least one user based on second data received from at least one 802.11ay sensor, combining the location information and the emotional quotient to generate one or more enhanced location analytics associated with the at least one user, and integrating the one or more enhanced location analytics with customer information in a partner database to derive one or more insights.

Technical advantages of certain embodiments of this disclosure may include one or more of the following. The systems and methods described herein may allow for enhanced location analytics by combining 11ay enhanced location information with the emotional quotient of a user, thereby providing a means to examine and analyze user behavior in various physical spaces. In another embodiment, the systems of the present disclosure may also allow for multi-factor authentication using 11ay heartbeat sensing, thereby eliminating the need for device authentication.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

The 802.11ay Wi-Fi standard, sometimes called “Wi-Gig” or “11ay”, operates on a 60 GHz frequency. The higher 60 GHz frequency of the 11ay allows for improved location accuracy over existing Wi-Fi technologies. This is because the channel bandwidth of the 60 GHz frequency is much wider, e.g., 800 MHz or higher. As the channel becomes wider, the ability to detect objects and/or people and pinpoint their location improves. Thus, while coarse location may be determined through existing Wi-Fi technology, fine-tuning of location (often within centimeter-level accuracy) may be made through 11ay.

Mapping a user's location and movement in a physical space using 11ay may enable a host of use cases in a variety of fields, including but not limited to education, retail, hospitality, and healthcare. These use cases may be further enhanced if it is known how the user is “feeling” in that physical space, which may also be determined using 11ay technology. By combining enhanced location information with an emotional quotient of a user, the resulting enhanced location analytics may enable superior and extremely personalized insights about the interplay between users and the given physical space. This may allow businesses to better understand and serve their customers, presenters to better reach their audience, schools to better serve their students, etc.

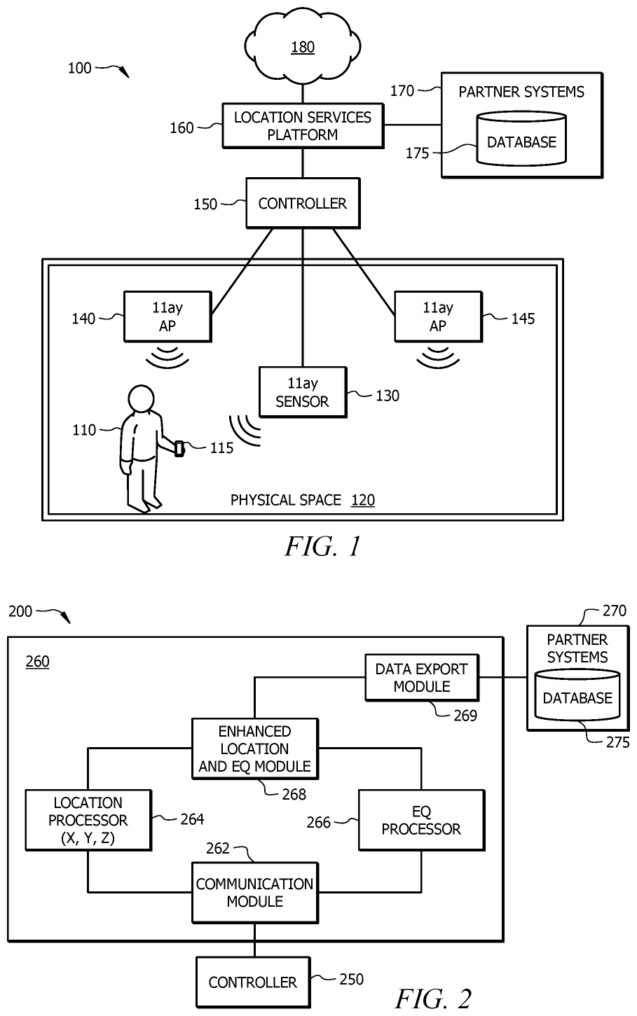

FIG. 1 depicts a system 100 for deriving enhanced location analytics by combining location information and an emotional quotient using 11ay Wi-Fi technology. The system 100 may include at least one 11ay access point 140 located in a physical space 120. The physical space 120 may include a conference room in an office building, a classroom in a university, a retail store, a commercial aircraft, a hospital, or any other physical space occupied by at least one user 110 for whom an emotional quotient may be generated. The user 110 in FIG. 1 may include a conference attendee, a student, a consumer, a passenger, a patient, or any person in the physical space 120 having (either within proximity and/or on his person) a device 115 capable of Wi-Fi connectivity. The device 115 may include a mobile phone, a laptop, a tablet, or any other device that is able to connect to a network 180 through the 11ay access point 140. For purposes of illustration, FIG. 1 shows the device 115 as a mobile phone. While the present disclosure describes the operation of system 100 in conjunction with one 11ay access point 140, it is be understood that system 100 may include any number of 11ay access points. For example, if physical space 120 is a very large space, it is contemplated that system 100 would include more than one 11ay access point 140, 145, as shown in FIG. 1.

The 11ay access point 140 may be configured to detect a device 115 of at least one user 110 in the physical space 120. Specifically, by using principles of radio sensing and reflection, the 11ay access point 140 may detect the physical presence of the device 115 associated with the user 110 in a specific location in the physical space 120. In an embodiment, the 11ay access point 140 may detect the presence of the device 115 of the user 110 using Received Signal Strength Indicator (RSSI) or Channel State Information (CSI). In another embodiment, the 11ay access point 140 may detect the presence of the device 115 of the user 110 based on room mapping and/or the proximity of the user's device 115 to certain other devices or areas within the physical space 120. It is to be understood that the presence of the user 110 and/or his device 115 may be detected by the 11ay access point 140 by any technological means known or developed in the art. In an embodiment, since the device 115 is within proximity of, or on the person of, the user 110, the detection of the physical presence of the device 115 may also result in determining the location of the user 110. Upon detecting the device 115 of the user 110, the 11ay access point 140 may transmit this location data (i.e., data relating to the physical location of the device 115 and/or the user 110 in the physical space 120, referred to hereafter as the “first data”) to a controller 150 in real-time, which may then transmit the first data to a location services platform 160 in real-time. In another embodiment, the hay access point 140 may transmit the first data directly to the location services platform 160 in real-time.

System 100 may further include at least one 11ay sensor 130. While the present disclosure describes system 100 in conjunction with one 11ay sensor 130, it is be understood that system 100 may include any number of 11ay sensors. In an embodiment, the 11ay sensor 130 may be located in substantial proximity to the user 110. For example, if the physical space 120 is a conference room, the 11ay sensor 130 may be placed as a hub on a conference table in the conference room. If the physical space 120 is an aircraft, the 11ay sensor 130 may be incorporated into an entertainment console that is made available to each passenger. In a retail setting, the 11ay sensor 130 may be strategically placed on a wall or along an aisle near a product display. In an embodiment, the proximity of the 11ay sensor 130 to the user 110 may enable the 11ay sensor 130 to more accurately sense emotional characteristics relating to the user 110. In an embodiment, the 11ay sensor 130 may comprise an 11ay millimeter wave sensor. In another embodiment, the 11ay sensor 130 may be configured into and as part of an 11ay access point 140.

The 11ay sensor 130 may be configured for the real-time sensing of one or more emotional characteristics of the user 110 based on principles of facial and gesture recognition. “Emotional characteristics” may comprise criteria that reflect the emotional state of the user, and may include facial expressions (e.g., furrowed brows, pursed lips, lack of expression, etc.), gestural movements (e.g., yawning, slow or fast blinking of the eyes, leaning in, etc.), cardiac rhythms (e.g., elevated heartrate indicating excitement, lowered heartrate indicating sleepiness, etc.), and the like. The 11ay sensor 130 may transmit these emotional characteristics (i.e., referred to hereafter as the “second data”) to the controller 150 in real-time, which may then transmit the first data to a location services platform 160 in real-time. In another embodiment, the 11ay sensor 130 may transmit the second data directly to the location services platform 160 in real-time.

Controller 150 may comprise a wireless local area network (LAN) controller and may include one or more modules for receiving the first data detected by the 11ay access point 140, and for receiving the second data sensed by the 11ay sensor 130. The controller 150 may further include one or more modules for transmitting the first data and the second data to the location services platform 160.

The location services platform 160 of system 100 may comprise a cloud-based platform that leverages existing Wi-Fi infrastructure to provide insights about users 110 and things within a physical space 120. As further explained below, the location services platform 160 may determine enhanced location information of the user 110 in the physical space 120 based on the first data received either via the controller 150 or directly from the 11ay access point 140. The location services platform 160 may further generate an emotional quotient of the user 110 based on the second data received either via the controller 150 or directly from the 11ay sensor 130.

Reference is now made to FIG. 2, wherein is shown a block diagram 200 depicting certain functionality of the location services platform 260 (element 160 of FIG. 1), as it relates to the present disclosure. FIG. 2 will be described in conjunction with one or more elements of FIG. 1. The location services platform 260 may include a communications module 262 for receiving the first data from the controller 250 (corresponding to element 150 of FIG. 1) or directly from the 11ay access point (element 140 of FIG. 1). The communications module 262 may further receive the second data from the controller 250 or directly from the 11ay sensor (element 130 of FIG. 1). The communications module 262 may send the first data to a location processor 264 and may send the second data to an emotional quotient processor 266. In an embodiment, the location services platform 260 may not include a communications module 262, and the first and second data may instead be sent from the 11ay access point (element 140 of FIG. 1) and the 11ay sensor (element 130 of FIG. 1) to the location processor 264 and the emotional quotient processor 266 (either directly or via the controller 250), respectively.

The location processor 264 may compute enhanced location information of the user (element 110 of FIG. 1) based on the first data received from the 11ay access point 140. While the 11ay access point 140 may detect the presence of the user's device 115 at a particular location in the physical space (element 120 of FIG. 1), the location processor 264 may refine that location to determine enhanced location information relating to the user 110. As described above, since the device 115 is within proximity of, or on the person of, the user 110, the first data corresponding to the location of the device 115 may further correspond to and/or may be used to determine the location of the user 110. As such, the location processor 264 may use the first data to determine enhanced location information of the user 110. In an embodiment, the enhanced location information may include geolocation information comprising x, y, z-coordinates of the user 110 relative to the 11ay sensor 130 and/or the 11ay access point 140. The x, y, z-coordinates of the user 110 may be determined with respect to the floor plan of the physical space 120. For example, if the physical space 120 in which the user 110 is located is a conference room, the location processor 264 may determine enhanced location information which may include x, y, z-coordinates corresponding to a particular seat in that conference room. If the physical space 120 is a retail store, the location processor 264 may determine enhanced location information which may include x, y, z-coordinates corresponding to a location in front of or near a particular product display. If the physical space 120 is a commercial aircraft, the location processor 264 may determine enhanced location information which may include x, y, z-coordinates corresponding to a particular seat in a particular row or section of the aircraft. The location processor 264 may transmit the enhanced location information to an enhanced location and emotional quotient module 268 of the location services platform 260.

The emotional quotient processor 266 may generate an emotional quotient of the user 110 based on second data transmitted by the 11ay sensor 130. While the 11ay sensor 130 may detect emotional characteristics such as facial expressions, gestural movements, and/or cardiac rhythms, the emotional quotient processor 266 may analyze and process this second data to generate an overall emotional quotient. For example, in the context of a conference room, if the 11ay sensor 130 detects that the user's 110 facial expressions is not smiling, that her gestural movements include yawning, and that her heartrate has slowed, the emotional quotient processor 266 may analyze and process all of this data received from the 11ay sensor 130 (collectively, the “second data”) to generate a real-time emotional quotient that indicates that the user 110 is bored or sleepy. In another example, if the 11ay sensor 130 detects that the user's 110 facial expression denotes a smile, that her physical movements indicate that she is leaning in, and/or that her heartrate is normal or slightly elevated, the emotional quotient processor 266 may analyze and process this second data received from the 11ay sensor 130 to generate an emotional quotient that indicates that the user is happy, engaged, and/or satisfied. The emotional quotient processor 266 may transmit the emotional quotient to the enhanced location and emotional quotient module 268 of the location services platform 260.

The enhanced location and emotional quotient module 268 may combine the enhanced location information determined by the location processor 264 and the emotional quotient generated by the emotional quotient processor 266 to generate enhanced location analytics. Specifically, the enhanced location and emotional quotient module 268 may overlay the emotional quotient on top of the enhanced location information. The resulting enhanced location analytics associated with the user 110 may indicate the emotional health of the user 110 not only as a function of his/her location within the physical space 120, but also as a function of other metrics, such as time. For example, in the context of a meeting or conference, the enhanced location analytics may indicate that the user 110 was happy or unhappy for a precise number of minutes (which may correspond to when the user 110 was viewing a particular slide or listening to a particular piece of information at a particular point in the presentation). In the context of an airline flight, the enhanced location analytics may indicate that the user 110 was nervous or afraid for a certain time period (which may correspond to the beginning of the flight), but became relaxed and content for a subsequent period of time (which may correspond to when the user turned on the entertainment console or received a beverage). In the retail context, the enhanced location analytics may indicate that the user 110 lingered around a particular product for a given amount of time which was longer than the amount of time the user 110 spent around other products, or that the user smiled at a particular point in time (which may correspond to a time when a certain product was demonstrated). The enhanced location analytics may incorporate a variety of time-related metrics, including but not limited to the total duration of an event or activity, duration of a particular emotion in the user, duration of the user's engagement with respect to the article or item he/she is engaging with, etc.

The enhanced location and emotional quotient module 268 may then transmit the enhanced location analytics to a data export module 269 of the location services platform 260. The data export module 269 may then export the enhanced location analytics to a partner system 270 having a customer database 275 (elements 170 and 175, respectively, of FIG. 1).

It is to be understood that the location services platform 260 may include any number of additional functions and modules designed to enhance location and spatial analytics, as understood by one of skill in the art.

With reference back to FIG. 1, the location services platform 160 may integrate the enhanced location analytics with customer information from one or more partner systems 170. By way of example, partner systems 170 may include systems of various partners such as video or web conferencing partners, airline partners, retail partners, educational institution partners, hospital/healthcare partners, and any other partners for whom it would be beneficial to obtain location and emotional quotient information from users and/or customers. A partner system 170 may include a database 175 for storing the customer information relating to a plurality of users. The database 175 may store specific information relating to particular users and/or generalized data relating to categories of users. For example, for a given user 110, customer information in the partner database 175 may include, depending on the partner, preferences of the user 110, prior experiences of the user 110, purchases of the user 110, etc. With respect to categories of users, the database 175 may store general information such as interests, experiences and purchases based on location, demographics, etc. The location services platform 160 may combine the enhanced location analytics derived for the user 110 in the physical space 120 with customer information stored in the partner's database 175 to thereby generate highly personalized insights. These insights are generally related to user behavior in the given physical space 120 and may enable providers to tailor services and experiences to ensure user satisfaction. For example, in the retail context, insights may include the areas or departments the user 110 is most interested in, the amount of time the user 110 spends and the types of purchases the user 110 makes in those areas/departments, and/or the frequency in which the user re-visits the same area/department. In an embodiment, the partner system 170 may send the insights to relevant parties in real-time, so that the services and experiences of the user 110 provided by the partner may be tailored to the user's 110 satisfaction. In another embodiment, the location services platform 160 and/or the partner system 170 may use the insights derived for one or more users to develop analytics relating to, e.g., the users, the physical space, etc.

By way of example, if the system 100 is deployed in a business or office context, the location services platform 160 may integrate with a partner system 170 of a third-party web/video conferencing provider having its own database 175 storing customer information relating to the user 110 and/or a plurality of users, i.e., users of the conferencing system. The location services platform 160 may combine the location information (determined based on the first data received from the 11ay access point 140) with the emotional quotient (generated based on second data received from the 11ay sensor 130) to generate enhanced location analytics associated with at least one user 110. The enhanced location analytics may indicate that, based on the user's 110 emotional quotient, the user 110 is beginning to lose interest in a presentation. The information may be integrated with customer information stored in the database 175 of the video/web conferencing partner system 170 to derive one or more insights. For example, an insight may include that the user 110 exhibits disinterest regarding certain subject matter, or that the user 110 loses interest after a certain number of minutes have elapsed. A variety of insights may be obtained. In one embodiment, these insights may be provided to the meeting organizer in real-time. In another embodiment, these insights may form the basis of analytics, so that the meeting organizer and/or the provider may begin to identify trends and patterns with respect to the way users responds to certain types of presentation materials.

In another example, if the system 100 is deployed in a commercial aircraft, the location services platform 160 may integrate with a partner system 170 of an airlines having a database 175 storing customer information of the user 110 and/or a plurality of users, i.e., passengers. In this example, enhanced location analytics may relate to one or more passengers and may be used to indicate for a given passenger, based on his/her emotional quotient, that he/she is feeling discomfort on the flight. The enhanced location analytics may be integrated with customer information stored in database 175 to derive one or more insights. Customer information in this context may be based on, for example, frequent flyer data, past history of the passenger, past issues encountered by the passenger and how they were resolved, etc. For example, the insights may indicate that the passenger will likely calm down after receiving a drink, or prefers a blanket to sleep. Because these insights may be provided to the flight crew in real time, the flight crew may attend to the passenger to ensure he/she is satisfied on the flight. In another embodiment, the insights may be used to identify trends and patterns relating to general on-flight customer experiences. For example, the trends and patterns may identify that passengers are more likely to be dissatisfied on longer flights, when they lack entertainment options, etc. These insights may enable businesses and providers to pinpoint issues and generally work toward solutions to improve customer/user satisfaction.

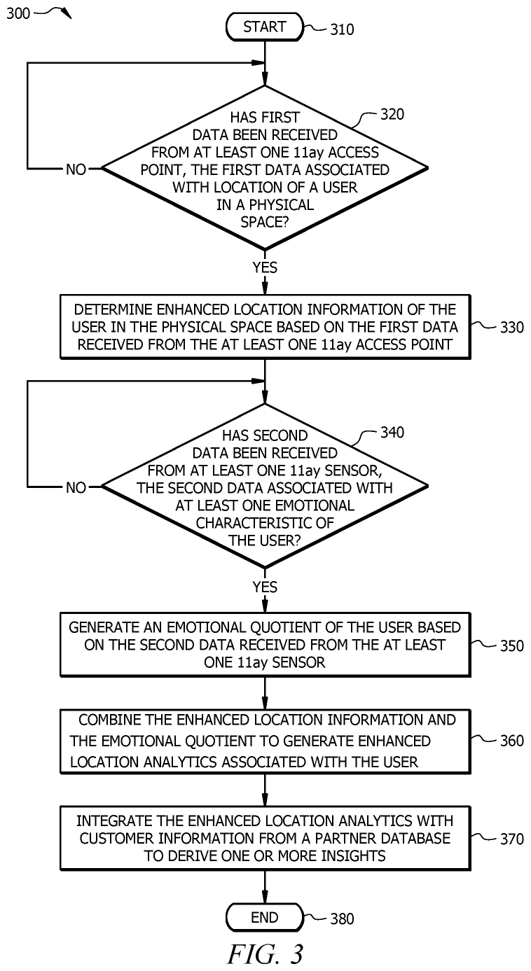

Reference is now made to FIG. 3, wherein is shown a method 300 for deriving enhanced location analytics by combining location information and an emotional quotient. Although method 300 is described from the perspective of the location services platform (element 160 of FIG. 1), it is to be understood that the method may be modified and applied to any device, module, or platform, whether or not described in the present disclosure, as understood by one of ordinary skill in the art. The method 300 may begin at step 310. At step 320, a determination may be made as to whether first data has been received from at least one 11ay access point, wherein the first data is associated with the location of at least one user in a physical space.

A physical space may include a conference room in an office building, a classroom in a university, a retail store, a commercial aircraft, a hospital, or any other physical space occupied by at least one user, of whom it would be beneficial to determine an emotional quotient (as defined herein). The user may include a conference attendee, a student, a consumer, a passenger, a patient, or any person in the physical space having (either within his proximity and/or on his person) a device capable of Wi-Fi connectivity. The device may include a mobile phone, a laptop, a tablet, or any other device that is able to connect to a network through the at least one 11ay access point.

The at least one 11ay access point may be configured to detect the presence of the device of the at least one user in the physical space. By using principles of radio sensing and reflection, the 11ay access point may detect the physical presence of the device associated with the at least one user in a specific location in the physical space. In an embodiment, the 11ay access point may detect the presence of the device using RSSI or CSI. In another embodiment, the 11ay access point may detect the presence of the device based on room mapping and/or the proximity of the device to certain other devices or areas of the physical space. In an embodiment, since the device of the at least one user is within proximity of, or on the person of the at least one user, the detection of the physical presence and/or location of the device may further correspond to and/or may be used to determine the location of the user himself Upon detecting the device of the at least one user, the 11ay access point may transmit this location data (i.e., data (referred to as the “first data”) relating to the physical location of the device and, therefore, associated with the location of the at least one user in the physical space) to the location services platform.

If, at step 320, it is determined that the first data has not been received from at least one 11ay access point, the method may proceed back to step 310, and a determination may again be made as to whether first data has been received from at least one 11ay access point. If, at step 320, it is determined that the first data has been received from at least one 11ay access point, the method may proceed to step 330, wherein enhanced location information of the user in the physical space may be determined based on the first data received from the at least one 11ay access point. In particular, while the 11ay access point may detect the presence of the user's device at a particular location in the physical space, the services platform may refine that location to determine enhanced location information relating to the user. As described above, since the device is within proximity of, or on the person of, the user, the first data corresponding to the location of the device may further correspond to and/or may be used to determine the location of the user. As such, the location processor may use the first data to determine enhanced location information of the user. Enhanced location information may refer to a refined information relating to the physical space. In an embodiment, the enhanced location information may include geolocation information comprising x, y, z-coordinates of the user with respect to the floor plan of the physical space. For example, if the physical space in which the user is located is a conference room, the enhanced location information may include x, y, z-coordinates corresponding to a particular seat in that conference room. If the physical space is a retail store, the enhanced location information may include x, y, z-coordinates corresponding to a location in front of or near a particular product display. If the physical space is a commercial aircraft, the enhanced location information may include x, y, z-coordinates corresponding to a particular seat in a particular row or section of the aircraft.

At step 340, a determination may be made as to whether second data has been received from at least one 11ay sensor, wherein the second data is associated with at least one emotional characteristic of the user. In an embodiment, the at least one 11ay sensor may be located in substantial proximity to the user. For example, if the physical space is a conference room, the at least one 11ay sensor may be placed as a hub on the conference table. If the physical space is an aircraft, the at least one 11ay sensor may be incorporated into an entertainment console that is made available to each passenger. In a retail setting, the at least one 11ay sensor may be strategically located on a wall or along an isle near a product display. In an embodiment, the proximity of the at least one 11ay sensor to the user may be important as the purpose of the 11ay sensor is to obtain facial and gestural characteristics of the user that may be most accurately ascertained by up-close sensing. In an embodiment, the at least one 11ay sensor may comprise an 11ay millimeter wave sensor. In another embodiment, the at least one 11ay sensor may be configured into and as part of the at least one 11ay access point.

The at least one 11ay sensor may be configured for sensing in real-time one or more emotional characteristics of the user based on principles of facial and gesture recognition. “Emotional characteristics” may comprise characteristics that may reflect the emotional state of the user, and may include facial expressions (e.g., furrowed brows, pursed lips, lack of expression, etc.), physical gestures/movements (e.g., yawning, slow or fast blinking, leaning in, etc.), heartbeat and/or heartrate patterns (e.g., elevated heartrate indicating excitement, lowered heartrate indicating sleepiness, etc.), and the like.

If, at step 340, it is determined that second data has not been received from at least one 11ay sensor, the method may proceed back to the completion of step 330, wherein a determination may continue to be made as to whether second data has been received from at least one 11ay sensor. If, at step 340, it is determined that the second data has been received from at least one 11ay sensor, the method may proceed to step 350, wherein an emotional quotient of the user may be generated based on the second data received from the at least one 11ay sensor. For example, in the context of a conference room, if the at least one 11ay sensor detects that the user's facial expression is not smiling, that her gestural movements include yawning, and that her heartrate has slowed, a real-time emotional quotient may be generated indicating that the user is bored or sleepy. In another example, if the at least one 11ay sensor detects that the user's facial expression denotes a smile, that her physical movements indicate that she is leaning in, and/or that her heartrate is normal or slightly elevated, an emotional quotient may be generated that indicates that the user is happy, engaged, and/or satisfied. In an embodiment, the emotional quotient may be generated in real-time.

At step 360, the enhanced location information determined in step 330 and the emotional quotient generated in step 350 may be combined to generate enhanced location analytics associated with the user. Specifically, the emotional quotient may be overlaid on top of the enhanced location information to generate enhanced location analytics associated with the user. Enhanced location analytics may indicate the emotional health of the user not only as a function of his/her location within the physical space, but also as a function of other metrics, such as time. For example, in the context of a meeting or conference, the enhanced location analytics may indicate that the user was happy or unhappy for a precise number of minutes (which may correspond to when the user was viewing a particular slide or listening to a particular piece of information at a particular point in the presentation. In the context of an airline flight, the enhanced location analytics may indicate that the user was nervous or afraid for a certain time period (which may correspond the beginning of the flight), but became relaxed and content for a subsequent period of time (which may correspond to when the user turned on the entertainment console or received a beverage). In the retail context, the enhanced location analytics may indicate that the user lingered around a particular product for a given amount of time which was longer than the amount of time the user spent around other products, or that the user smiled at a particular point in time (which may correspond to a time when a certain product was demonstrated). The enhanced location analytics may incorporate a variety of time-related metrics, including but not limited to the total duration of an event or activity, duration of a particular emotion in the user, duration of the user's engagement with respect to the article or item he/she is engaging with, etc.

At step 370, the enhanced location analytics may be integrated with customer information from a partner database of a partner system to derive one or more insights. The partner database may store specific information relating to particular users and/or generalized data relating to categories of users. For example, for a given user, customer information in the partner database may include preferences of the user, prior experiences of the user, purchases of the user, and/or other data relating to the user. With respect to categories of users, the database 175 may store general information such as interests, experiences and purchases based on location, demographics, etc. When the enhanced location analytics are integrated with the customer information, the resulting insights are generally related to user behavior in the given physical space and may enable providers to tailor services to ensure user satisfaction. In an embodiment, the partner system may send the insights to relevant parties in real-time, so that the services experienced by the user may be tailored to the user's satisfaction. In another embodiment, the location services platform and/or the partner system may user the insights derived for one or more users to develop analytics relating to, e.g., the users, the physical space, etc. At step 380, the method may end. The systems and methods of the present disclosure may be beneficial in various use cases. For example, the present disclosure may have applicability for any hospitality-related industry (hotels, restaurants, travel, etc.) that seeks to improve customer satisfaction at scale. For example, in the airline industry, airplanes may be fitted with 802.11ay access points and sensors which sense customer location and emotional quotient in real time. The 11ay access points may be distributed throughout the carrier, and sensors may be incorporated into the entertainment console of each passenger. Enhanced location analytics may be derived for each passenger. When this information is integrated with customer context from the airline's own database (which may store information about each new and/or returning passenger), an insight may be generated and sent to the flight crew. Thus, the flight crew may be equipped with information about a passenger's emotional quotient and be given recommendations for actions to be taken to improve the satisfaction of that passenger. Using the enhanced location analytics and/or insights derived by the location services platform, the flight crew may monitor passenger satisfaction/unsatisfaction and address any negative issues in real-time. Additionally, the airlines may use large data sets to derive trends and analytics that may help determine where time and resources should be invested, as well as determine what areas they may need to further train their flight crew.

In another example, the present disclosure may have applicability in the context of business meetings and conferences, where leaders, presenters, and/or meeting organizers may desire performance indicators to determine activity or participation level of each attendee, whether attendees were happy or unhappy when looking at a particular slide or heard a piece of information, and how many were contributing to the discussion. These insights will help the presenter/organizer determine the success of the meeting. Additionally, because the insights may be derived in real time, they may be given to the presenter during the meeting itself. In this use case, one or more 11ay access points may be placed in the conference room, and sensors may be placed as hubs on conference room tables. The emotional quotient of the participants may be determined, including by looking at facial expressions and gestures (furrowed brows, yawns, closing eyelids, pursed lips, etc.) The location services platform may chart out this information for the conference room space by overlaying the data on the physical map. This information may be derived for the occupant of each seat in the conference room.

In yet another example, the present disclosure may have applicability in the retail industry, as retail stores may generate reports about the emotional quotient of users as they walk through different isles of the store. This may help in product or marketing testing where stores want to see the result of product placement in different areas of the store. Additionally, this data may be exported to partners so that they understand how users react when they look at their products.

The principles described above and shown in conjunction with FIGS. 1-3 may be extended into other applications outside of location analytics. For example, similar principles may be used for adaptive multi-factor authentication. Multi-factor authentication generally refers to the verification of a user's identity by requiring multiple credentials. Typically, when a user desires to authenticate through a device, multi-factor authentication requires another device owned by the user to verify the identity. Once the user gives the correct response on the other device, the identify verification is completed. The drawback to this method is that identity is tied with one or more devices. Whoever has access to the one or more devices can fraudulently claim to be the user.

Thus, the present disclosure proposes a way use the principles described in this disclosure to decouple identity from the device by using 11ay sensing, and specifically, by using the unique signature of heartbeats as identified through 11ay millimeter wave radio reflections. Heartbeat signatures are unique to every individual. Even when a user is exercising and the pulse is rapid, the overall electrical signature of the heartbeat remains the same as it depends on the physical shape of the heart. This unique signature can be tracked by 11ay (60 GHz) millimeter wave radios and matched with a particular user.

In one embodiment, the system may authenticate the identity of a user through 11ay access points. As shown in FIG. 1, a conference room may include at least one 11ay access point 140 and at least one 11ay sensor 130 for detecting a user. The 11ay access point 140 may be mounted on a wall, and the 11ay sensor may be on a conference table hub. Once a user 110 enters the conference room and logs into a meeting via his laptop, a multi-factor authentication on his device may ask for a second method of verifying the user's identity. User credentials could be shared manually by the user. The 11ay access point 140 along with the location services platform 160 may identify the location of the laptop through which the user is trying to log in. The 11ay sensor 130 may read the heartbeat signature of the user 110 and verify it uniquely to the user. So, the presence of the user in the room may be verified by 11ay access point and the location services platform 160, and the identity of the user 110 may be verified through user credentials entered and the heartbeat signature of the user 110.

In another embodiment, the same principles may be used to preclude duress-based user login. For example, if a user desires to make a digital payment, and the user is already logged into an application on a mobile device using his/her credentials. Multi-factor authentication may trigger measurement of heartbeat signatures via an 11ay sensor integrated into the mobile device. The heartbeat sensor may ordinarily be verified to make payment. However, if the user has been placed under duress (e.g., forced to provide biometric authentication against his/her will), then vital signs measured by the 11ay sensor may identify this condition and require a different means of authentication.

In sum, the present disclosure provides systems and methods for enhanced location analytics by combining 11ay enhanced location information with the emotional quotient of a user, thereby providing a means to examine and analyze user behavior in various physical spaces. The present disclosure also provides systems for multi-factor authentication using 11ay sensing.

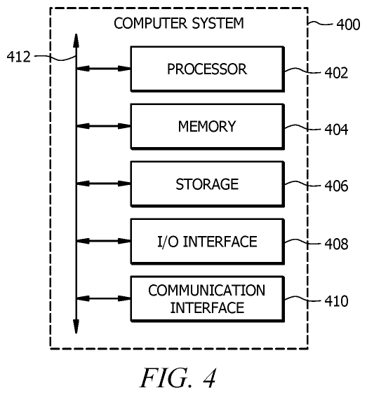

Reference is now made to FIG. 4, wherein is shown an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein. Embodiments according to the disclosure are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

What is claimed is:

1. A system, comprising:
one or more processors; and
one or more computer-readable non-transitory storage media comprising instructions that, when executed by the one or more processors, cause one or more components of the system to perform operations comprising:
determining enhanced location information of at least one user in a physical space based on first data received from at least one 802.11ay access point;
generating an emotional quotient of the at least one user based on second data received from at least one 802.11ay sensor;
combining the enhanced location information and the emotional quotient to generate one or more enhanced location analytics associated with the at least one user; and
integrating the one or more enhanced location analytics with customer information in a partner database to derive one or more insights.

2. The system of claim 1, wherein the at least one 802.11ay sensor comprises:
one or more millimeter wave sensors.

3. The system of claim 1, wherein the second data comprises:
emotional characteristics indicating an emotion of the at least one user.

4. The system of claim 3, wherein the emotional characteristics comprise:
at least one of facial expressions, gestural movements, and cardiac rhythms.

5. The system of claim 1, wherein at least one of the enhanced location information and the emotional quotient are generated in real-time.

6. The system of claim 1, wherein the one or more insights are associated with user behavior in the physical space.

7. The system of claim 1, wherein the partner database stores customer information relating to a plurality of users.

8. A method, comprising:
determining enhanced location information of at least one user in a physical space based on first data received from at least one 802.11ay access point;
generating an emotional quotient of the at least one user based on second data received from at least one 802.11ay sensor;
combining the enhanced location information and the emotional quotient to generate one or more enhanced location analytics associated with the at least one user; and
integrating the one or more enhanced location analytics with customer information in a partner database to derive one or more insights.

9. The method of claim 8, wherein the at least one 802.11ay sensor comprises:
one or more millimeter wave sensors.

10. The method of claim 8, wherein the second data comprises:
emotional characteristics indicating an emotion of the at least one user.

11. The method of claim 10, wherein the emotional characteristics comprise:
at least one of facial expressions, gestural movements, and cardiac rhythms.

12. The method of claim 8, wherein at least one of the enhanced location information and the emotional quotient are generated in real-time.

13. The method of claim 8, wherein the one or more insights are associated with user behavior in the physical space.

14. The method of claim 8, wherein the partner database stores customer information relating to a plurality of users.

15. One or more computer-readable non-transitory storage media embodying instructions that, when executed by a processor, cause performance of operations comprising:
determining enhanced location information of at least one user in a physical space based on first data received from at least one 802.11ay access point;
generating an emotional quotient of the at least one user based on second data received from at least one 802.11ay sensor;
combining the enhanced location information and the emotional quotient to generate one or more enhanced location analytics associated with the at least one user; and
integrating the one or more enhanced location analytics with customer information in a partner database to derive one or more insights.

16. The one or more computer-readable non-transitory storage media of claim 15, wherein the at least one 802.11ay sensor comprises:
one or more millimeter wave sensors.

17. The one or more computer-readable non-transitory storage media of claim 15, wherein the second data comprises:
emotional characteristics indicating an emotion of the at least one user.

18. The one or more computer-readable non-transitory storage media of claim 17, wherein the emotional characteristics comprise:
at least one of facial expressions, gestural movements, and cardiac rhythms.

19. The one or more computer-readable non-transitory storage media of claim 15, wherein at least one of the enhanced location information and the emotional quotient are generated in real-time.

20. The one or more computer-readable non-transitory storage media of claim 15, wherein the one or more insights are associated with user behavior in the physical space.
